(19) United States
(12) Patent Application Publication
(10) Pub. No.: US 2005/0063521 A1
(43) Pub. Date: Mar. 24, 2005

(54) Targeted information recognition in a voice communication

(76) Inventor: Tushar Ramesh Shah, Lombard, IL (US)

Correspondence Address: Docket Administrator (Room 3J-219);Lucent Technologies Inc., 101 Crawfords Corner Road, Holmdel, NJ, 07733-3030, US

(21) Appl. No.: 10/668,848

(22) Filed: Sep. 23, 2003

(51) Int. Cl. H04M 1/64

(52) U.S. Cl. 379/88.01; 379/88.22

(57) ABSTRACT

Speech recognition technology is used to review voice communications directed to a party for targeted information (e.g., telephone number, URL, e-mail address) and, if the information is identified, the party may invoke a connection option and/or delivery option as may be appropriate. Connection options enable the party to initiate a connection (or “call,” in the case of a telephone number) to a communication device associated with the targeted information. Delivery options enable the party to receive a text message including the targeted information.

### FIELD OF THE INVENTION

This invention relates generally to the field of speech recognition and, more particularly, to using speech recognition to identify targeted information (e.g., phone number, URL, e-mail address) in a voice communication.

### BACKGROUND OF THE INVENTION

Communication systems are well known in which a party (using, for example, a wireless or wireline phone) may receive a voice communication from another party (also using, for example, a wireless or wireline phone). The voice communication may be received, for example, by a calling or called party coincident to an active telephone call or by a called party coincident to reviewing voicemail message(s) associated with previous unanswered calls. The voice communication may comprise, for example, a “live” or recorded human voice or synthesized voice.

Oftentimes, the voice communication includes information that the recipient may wish to use or take note of for future use. For example and not limitation, the voice communication may include information such as a phone number, URL and/or e-mail address which the recipient may wish to use to make a telephone call, access a web page or send an e-mail, respectively. However, most particularly when the recipient is engaged in other activities such as driving, cooking, etc. or when the recipient does not have ready access to a pen and paper, the recipient may find it difficult or impossible to make a note of the desired information. Consequently, unless the recipient is able to interrupt their activity to make a note, the recipient may resort to memorization (or at least attempted memorization) of the information. A related problem is that the recipient may wish to use the desired information substantially immediately after receiving it (while it is still fresh in the recipient's mind) to initiate a further communication (e.g., to make a call, access a web page, send an e-mail) yet the recipient may still be engaged in driving or other activity that would make it difficult or inconvenient to do so.

### SUMMARY OF THE INVENTION

These problems are solved and a technical advance is achieved in the art by a feature whereby speech recognition technology is used to review a voice communication received by a party for targeted information (e.g., telephone number, URL, e-mail address) and, if the information is identified, the party may invoke a connection option as may be appropriate, to connect to the telephone number, URL, e-mail address; and/or the party may invoke a delivery option to receive a text message including the information.

In one embodiment, a method of the invention comprises reviewing a voicemail message for a directory number associated with a communication device. If a directory number is identified in the voicemail message, an automatic call option is provided whereby the party may initiate a call, without dialing the directory number, to a communication device associated with the directory number.

In another embodiment, a method of the invention comprises delivering a voice communication to a party and receiving a request from the party for targeted voice recognition. Responsive to the request, at least a portion of the voice communication is reviewed for targeted information. If targeted information is identified, a delivery option and/or connection option is provided. The delivery option enables a party to request delivery of the targeted information to a specified device and the connection option enables the party to initiate a connection to a communication device associated with the targeted information.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a flowchart of a method wherein speech recognition is used to identify a phone number within a recipient voicemail message and wherein the recipient may exercise an automatic call option associated with the phone number according to an embodiment of the invention; and

FIG. 3 is a flowchart of a method wherein speech recognition is used to identify targeted information within a recipient voice communication and wherein the recipient may exercise a delivery option and/or connection option associated with the targeted information according to an embodiment of the invention.

### DESCRIPTION OF THE PREFERRED EMBODIMENT(S)

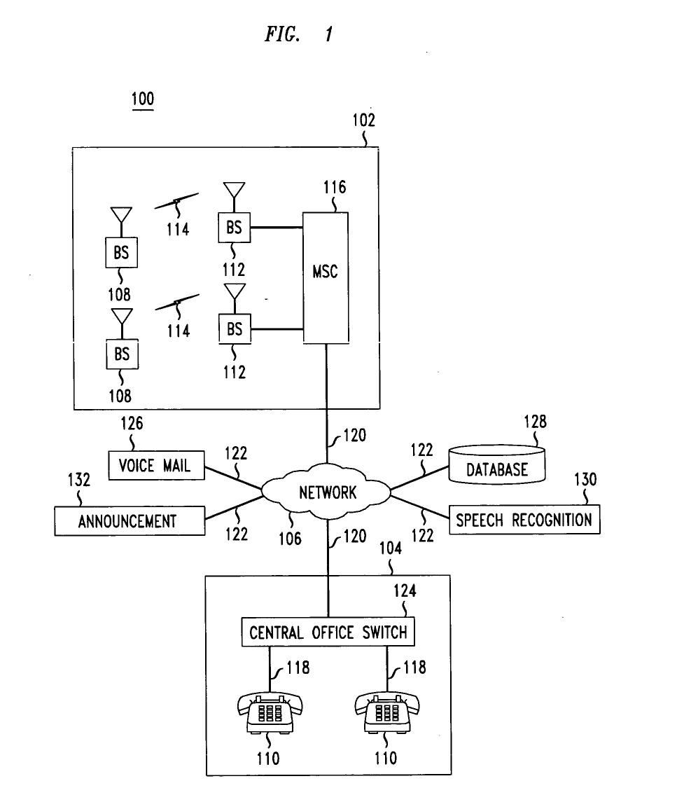

FIG. 1 shows by way of example and not limitation, a communication system 100 comprising a wireless subsystem 102 and a wireline subsystem 104 interconnected by a network 106. The wireless and wireline subsystems 102, 104 may comprise private systems or public systems or a combination thereof. The network 106 may be a private or public network implemented using any appropriate transmission, switching and routing technologies, as are known in the art, including but not limited to Internet Protocol (IP) and Asynchronous Transfer Mode (ATM) technologies.

Distributed throughout the wireless subsystem 102 is a plurality of mobile units (e.g., wireless phones) 108. Distributed throughout the wireline system 104 is a plurality of wireline units 110 (e.g., wireline telephones). Generally, any of the mobile or wireline units 108, 110 may be sources or recipients of calls. Depending on the call, as will be appreciated, the source(s) and recipient(s) may each reside in the wireless network 102 or the wireline network 104, or the source(s) and recipients may be divided among the wireless and wireline networks.

Wireless subsystem 102 comprises in one embodiment a digital cellular communication system. The mobile units 108, generally, are adapted to roam between different RF coverage areas of the wireless subsystem, sometimes referred to as “cells” (not shown) served by base stations 112. The wireless subsystem 102 may include multiple base stations 112 serving multiple cells. Wireless calls to (or from) the mobile units 108 are communicated via RF resources 114 from (or to) the base stations, typically by a predefined wireless protocol such as, for example, Global System for Mobile Communications (GSM), Personal Communications Service (PCS), Code Division Multiple Access (CDMA), Time Division Multiple Access (TDMA) and Advanced Mobile Phone Service (AMPS).

The base stations 112 are connected via links 118 to a call processing control entity, commonly known as a mobile switching center (MSC) 116, which routes the calls, as may be appropriate, to or from the network 106 and the wireline subsystem 104. The links 118 may comprise, without limitation, conventional subscriber lines, ISDN lines, Ethernet LAN, and the like. The MSC 116 may comprise, for example, a 5ESS® switching system, available from Lucent Technologies, Inc. The MSC 116 includes a memory and processor (not shown), for storing and executing software routines for processing and switching calls, for providing various call features to calling parties and for providing access to the network 106 and wireline subsystem 104. The MSC 116 may be configured for operation with generally any suitable circuit, cell, or packet switching technology.

Wireline subsystem 104 comprises in one embodiment the public switched telephone network (PSTN). The wireline units 110 of the PSTN are connected via links 118 to a local call processing control entity commonly referred to as a central office switch 124. The links 118 may comprise, without limitation, conventional subscriber lines, ISDN lines, Ethernet LAN, and the like. The central office switch 124 may comprise, for example, a 5ESS® switching system, available from Lucent Technologies, Inc. The central office switch 124 includes a memory and processor (not shown), for storing and executing software routines for processing and switching calls, for providing various call features to wireline units 110 and for providing access to the network 106 and wireless subsystem 102.

As shown, the communication system 100 of FIG. 1 includes a single MSC 116 and single central office switch 124. However, as will be appreciated, the MSC 116 and central office switch 124 are functional entities that may reside in multiple physical switches or combined into a single switch.

Links 120 carry signaling information and/or payload information between central office switch 124 and network 106, and/or between MSC 116 and network 106. In one embodiment, the payload information comprises voice information. Alternatively or additionally, the payload information may comprise information associated with video, data, text or generally any communication media. The links 120 are logical links that may be physically realized, without limitation, by conventional subscriber lines, ISDN lines, WAN links, wireless links, and the like.

As shown, data links 122 connect the network 106 to a messaging system 126 (such as a voice mail system), database 128, speech recognition system 130 and announcement system 132. The data links 122 may comprise LAN or WAN links or virtually any type of link suitable for transporting voice or data to and from the network 106.

The messaging system 126 is adapted to record messages (e.g., voice mail messages) from calling parties desiring to leave messages after unanswered calls and play back such messages to called parties upon request, as is well known. The database 128 stores information associated with various subscribers of the wireless or wireline subsystems 102, 104.

The speech recognition system 130 is adapted to review voice communications within certain active calls as requested or instructed by the MSC 116 or central office switch 124 or within voicemail messages as requested or instructed by the messaging system 126. Speech recognition systems are known in the art and will not be described in detail herein. Suffice it to say that the speech recognition system reviews the voice communication within the active call or voicemail message in any manner known or to be devised in the future, for the presence of certain targeted information. According to embodiments of the present invention, the targeted information may include for example, phone number, URLs and/or e-mail addresses.

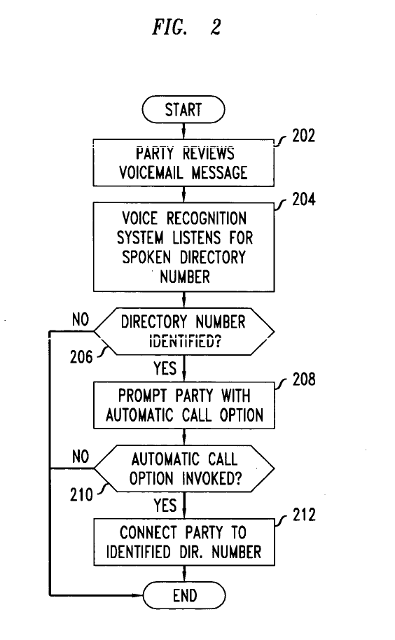

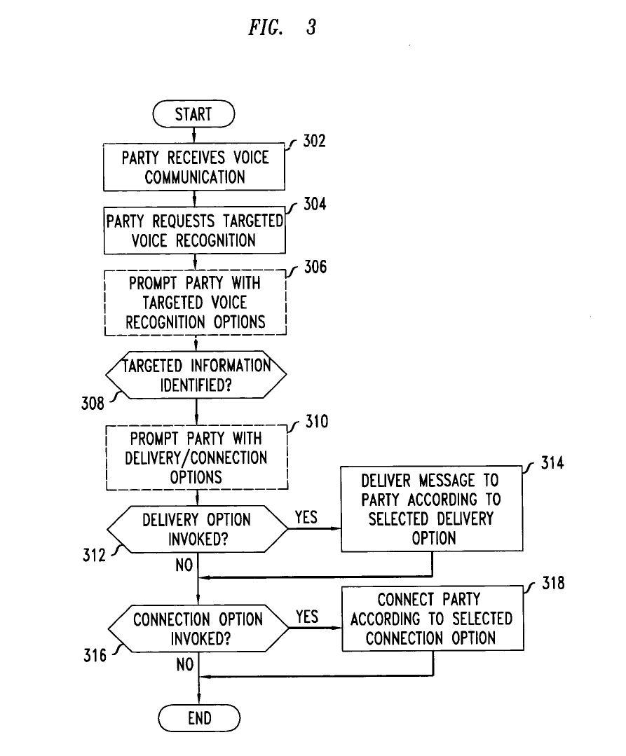

The announcement system 132 provides announcements, on occasion, to mobile or wireline units. For example, in embodiments of the present invention, as will be described in greater detail in relation to FIG. 2 and FIG. 3, an announcement may be provided to prompt users of mobile or wireline units with an automatic call option whereby the user can automatically connect to a phone number identified in a voicemail message or an announcement may be provided to prompt users with targeted voice recognition options and/or delivery/connection options.

As will be appreciated, the messaging system 126, database 128, speech recognition system 130 and announcement system 132 are logical entities that may reside individually or collectively within a single device, within separate devices or within multiple, distributed devices. The messaging system 126, database 128, speech recognition system 130 or announcement system 132 may be linked directly to the MSC 116 or central office switch 124, rather than (or in addition to) the network 106.

Turning now to FIG. 2, there is shown a flowchart of a method that may be implemented in the communication system of the type shown in FIG. 1, to identify a phone number within a recipient voicemail message and, if so requested or instructed, to automatically call the number. The steps of FIG. 2 are implemented, where applicable, using stored software routines within a called party phone, MSC 116, central office switch 124, voice mail system 126, speech recognition system 130 and/or announcement system 132.

At step 202, a party (or “message recipient”) reviews a voice mail message associated with a previous unanswered call. The recipient may request message review, for example, by calling a directory number or entering a code, etc., associated with messaging system 126, causing the messaging system to retrieve and play back message(s) directed to the recipient, as is well known. The recipient may comprise a user of a wireless or wireline phone. For example, in the case where the recipient comprises a mobile unit 108, MSC 116 receives and routes the message review request from the recipient to the voicemail system 126 as well as receives and routes recorded message(s) from the voicemail system 126 to the mobile unit 108. Similarly, in the case where the recipient comprises a wireline unit 110, central office switch 124 receives and routes the message review request from the recipient to the voicemail system 126 as well as receives and routes recorded message(s) from the voicemail system 126 to the wireline unit 110.

At step 204, the speech recognition system 130 reviews the voice mail message for the presence of phone number(s). In one embodiment, the speech recognition system reviews messages for the presence of phone number(s) automatically, at the time of message playback to the recipient. Alternatively or additionally, the speech recognition system may review messages for the presence of phone number(s) on request or instruction from the messaging system 126, MSC 116, central office switch 124 and/or recipient phone 108, 110. Still further, the speech recognition system may review messages at the time the message is recorded into the messaging system rather than at time of message playback. In alternative embodiments, the speech recognition system upon identifying a directory number in the voice mail message may store the identified number in an internal memory (not shown) or cause the identified number to be stored in the database 128. The number is stored in association with subscriber/recipient data and/or message data to facilitate later retrieval of the number by the MSC 116, central office switch 124, voice mail system 126, speech recognition system 130 or announcement system 132.

In one embodiment, the speech recognition system determines a phone number is present in the voicemail message upon recognizing an accumulation of phonetic sounds representative of numeric digits within a period of time, which accumulation may represent different numbers of digits. For example, the speech recognition system may identify a set of seven digits (i.e., comprising a three digit office code and a four digit line code), ten digits (i.e., comprising a three digit area code, three digit office code and a four digit line code) or greater than 10 digits (i.e., including a 1- to 3-digit country code followed by a three digit area code, a three digit office code and a four digit line code). The speech recognition system may be designed to recognize digits in virtually any spoken language. Further, the speech recognition system may recognize certain precursor utterances (e.g., “the number is . . . ”), alternative pronunciations and the like to assist in identifying phone number(s) in the voicemail message. Nevertheless, as will be appreciated, the particular manner in which the speech recognition system operates to recognize particular digits does not comprise a part of the present invention.

If a directory number is identified, determined at step 206, the speech recognition system 130 at step 208 causes the announcement system 132 to prompt the recipient with an “automatic call option,” whereby the recipient may be connected with the number substantially automatically (e.g., responsive to a user signal). For example, the announcement might state: “The directory number [(recite identified number)] may be called automatically. If you wish to make a call to this number, please press ‘1’”. As will be appreciated, a variety of different keys, keystroke sequences and the like might be used to indicate a desire to exercise the automatic call option. Similarly, user displays (e.g., menus, pop-up screens, icons, etc.) might be used whereby the user may select the automatic call option by pointing and clicking on a displayed item associated with the automatic call option.

If the automatic call option is invoked, determined at step 206, the recipient is connected to the directory number at step 212. In one embodiment, the speech recognition system 130 detects the user signal invoking the automatic call option and thereupon sends the indicated number to the MSC 116 and/or central office switch 124 and instructs the MSC and/or central office switch to set up the connection. Responsive to receiving the number and/or instruction, the MSC 116 and/or central office switch 124 connects the recipient to the indicated number. The process ends after the call is connected. The process also ends if a directory number is not identified at step 206 or if the recipient does not invoke the automatic call option at step 210. The process may begin again at such time as the recipient reviews another voicemail message at step 202. It is noted, the term “connect” or “connected” as used herein refers to the steps of initiating a call by allocating communication resources between the recipient and a mobile or wireline phone associated the indicated number and ringing the indicated number. The connection may or may not result in a completed call.

As will be appreciated, network devices other than or in addition to the speech recognition system 130 might be used to detect the user signal invoking the automatic call option and signal the MSC 116 or central office switch 124 to set up the connection between the recipient and the indicated number. Further, the MSC 116 or central office switch 124 might itself detect the user signal invoking the automatic call option (depending on whether the recipient is using a mobile unit 108 or wireline unit 110) and, upon such detection, queries the speech recognition system 130 or database 128 for the identified number and initiate the connection.

Turning now to FIG. 3, there is shown a flowchart of a method that may be implemented in the communication system of the type shown in FIG. 1, to identify targeted information within a recipient voice communication and if so requested or instructed, to deliver the information to the recipient or to connect the recipient to a communication device or entity associated with the targeted information. For example, the targeted information may comprise a phone number, URL or e-mail address; the information may be delivered via short message service, e-mail or a requested software tool to the recipient; and the recipient may be connected to the phone number, URL or e-mail address to return the communication. The steps of FIG. 3 are implemented, where applicable, using stored software routines within a called party phone, MSC 116, central office switch 124, voice mail system 126, speech recognition system 130 and/or announcement system 132.

At step 302, a party (“recipient”) receives a voice communication. The voice communication may be received, for example, coincident to an active call or a voice mail message associated with a previous unanswered call. In the former case, the recipient may be the calling or called party. The recipient receives the communication from the MSC 116 or central office switch 124, as the case may be, depending on whether the recipient is using a wireless or wireline phone during the active call or to review messages.

At step 304, the recipient requests targeted voice recognition. For example, the recipient may request voice recognition to identify the phone number, URL, e-mail address or generally any information in the communication that the recipient may wish to use or make later use of. In one embodiment, the recipient requests the targeted voice recognition by entering a code (e.g., *22) on the recipient's phone. The recipient might use different codes to target different types of information (e.g., different codes to detect phone number, URL, e-mail, etc.) Optionally, at step 306, responsive to a recipient signal, the announcement system prompts the recipient with different available codes and/or user displays from which the recipient may select various type(s) of targeted voice recognition.

In the preferred embodiment, the method presumes that targeted voice recognition may be accomplished retroactively, to identify information that occurred during the communication but prior to the request (as well as information after the request). For example, the recipient, having heard a phone number in the communication, may request targeted voice recognition to identify the phone number and, as will be described in greater detail hereinafter, to perhaps deliver a text message including the phone number and/or to connect to the phone number. It is contemplated that digital recording media (not shown) within the MSC 116 and/or central office switch 124 may be used to record and playback the voice communication so as to enable such retroactive voice recognition to be accomplished.

Alternatively, the voice recognition may be accomplished prospectively, to identify information occurring after the request. In such case, for example, a recipient might request targeted voice recognition for a phone number just in case a phone number will be voiced in the communication; or the recipient, having already heard a phone number, might request targeted voice recognition and then repeat (or ask the speaker to repeat) the phone number so that it may be identified by the voice recognition system.

At step 307, the speech recognition system 130 reviews the voice communication for the presence of the targeted information (e.g., phone number, URL, e-mail, etc.). In the preferred embodiment, the speech recognition reviews the voice communication responsive to request from the recipient (step 304). Alternatively or additionally, the speech recognition system may review the voice communication for the presence of targeted information on request or instruction from the messaging system 126, MSC 116, central office switch 124. Still further, the speech recognition system may review the voice communication in real-time rather than by retrieving or playing back the voice communication. In alternative embodiments, the speech recognition system upon identifying target information in the voice communication may store the information in an internal memory (not shown) or cause the information to be stored in the database 128. The information is stored in association with subscriber/recipient data and/or message data to facilitate later retrieval of the information by the MSC 116, central office switch 124, voice mail system 126, speech recognition system 130 or announcement system 132.

As will be appreciated, the speech recognition system may determine information is present in the voice communication upon recognizing different numbers of voiced digits, different voice patterns and the like. For example, as has been described in relation to FIG. 2 for phone number recognition, the speech recognition system may identify a set of seven digits, ten digits or greater than 10 digits and/or extensions or other supplemental numbers in the voicemail message. For URL recognition, the speech recognition system may recognize information having a “www” prefix, or a “dot-com” suffix or other indicia of a web address. Similarly, for e-mail addresses, the speech recognition might recognize a particular prefix or suffix indicating an e-mail address.

If targeted information is identified, determined at step 308, the speech recognition system 130 optionally, at step 310 causes the announcement system 132 to prompt the recipient with delivery and/or connection options. For example, delivery options might include sending an e-mail message or text message to the recipient including the targeted information, such that the recipient will have a record of the information without having personally written down the information. As another example, a delivery option might comprise sending the information to a software tool, such as Microsoft Outlook™, whereby the targeted information is associated with a task entry, calendar entry or the like.

In one embodiment, connection options include connecting the recipient to an endpoint corresponding to the information. For example, as has been described in relation to FIG. 2, a connection option may connect the recipient to an identified phone number. Connection options might also connect the recipient to an e-mail address, URL or other endpoint as may be appropriate corresponding to the identified information. The recipient may select the delivery/connection options by pressing various keys, entering keystroke sequences, codes or the like, either independently or responsive to prompting by the announcement system.

If a delivery option is invoked, determined at step 312, a message including the targeted information is delivered to the recipient at step 314 via a selected medium or software tool (or optionally, a default medium). In such manner, the recipient receives a text record, task item, calendar entry or the like including the information without the burden of writing down the information. If a connection option is invoked, determined at step 316, the recipient is connected to an endpoint associated with the identified information at step 318. In such manner, the recipient may automatically call a number, send an e-mail or connect to a web site associated with the identified information, as may be appropriate.

In one embodiment, the detection of user signal(s) invoking delivery options or connection options is accomplished by the speech recognition system 130; and, responsive to the detection, the speech recognition system sends instructions to the MSC 116, central office switch 124 or other network device, as may be appropriate, to execute the requested delivery or connection option(s). As will be appreciated, network devices other than or in addition to the speech recognition system 130 might be used to detect user signal(s) invoking delivery or connection options and signal the MSC 116, central office switch 124 or other network device to execute the requested delivery or connection options. Further, the MSC 116 or central office switch 124 might itself detect user signal(s) invoking delivery or connection options (depending on whether the recipient is using a mobile unit 108 or wireline unit 110) and, upon such detection, queries the speech recognition system 130 or database 128 for the targeted information and either executes (or sends instructions to other network devices to execute) the requested delivery or connection options.

In one embodiment, the process ends after the recipient is connected to an endpoint according to a selected connection option. The process also ends if targeted information is not identified at step 308 or if the recipient does not invoke a connection option at step 316. The process may begin again at such time as the recipient reviews another voice communication at step 302. It is noted, the term “connect” or “connected” as used herein refers to the steps of allocating communication and/or software resources to facilitate a communication between the recipient and an endpoint associated with the targeted information. The connection may or may not result in a completed call, sent e-mail or successful access to a website, for example, depending on the targeted information.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a communication system including a voicemail system for recording and playing back voicemail messages directed to a party, a method comprising:
reviewing a voicemail message for a directory number associated with a communication device; and
if a directory number is identified in the voicemail message, providing an automatic call option whereby the party may initiate a call, without dialing the directory number, to a communication device associated with the directory number.

2. The method of claim 1 wherein the step of reviewing is accomplished by a speech recognition system coincident to playback of the voicemail message to the party.

3. The method of claim 1 wherein the step of reviewing is accomplished by a speech recognition system coincident to the voicemail message being recorded into the voicemail system.

4. The method of claim 1 wherein the step of providing an automatic call option comprises:
sending a message to the party indicating availability of the automatic call option;
receiving a request from the party to invoke the automatic call option; and
responsive to the request, initiating a call to the communication device associated with the directory number identified in the voicemail message.

5. The method of claim 4 wherein the step of sending the message comprises sending indicia of the directory number identified in the voicemail message.

6. The method of claim 4 wherein the step of sending the message comprises sending indicia of an action required for the party to invoke the automatic call option.

7. A method comprising:
delivering a voice communication to a party;
receiving a request from the party for targeted voice recognition;
responsive to the request, reviewing at least a portion of the voice communication for targeted information; and
if targeted information is identified in the voice communication, providing one or more of: a delivery option whereby the party may request delivery of the targeted information; and a connection option whereby the party may initiate a connection to a communication device associated with the targeted information.

8. The method of claim 7 wherein the step of delivering comprises playing a voicemail message directed to the party.

9. The method of claim 7 wherein the step of delivering comprises sending a voice communication to the party coincident to an active call.

10. The method of claim 7 wherein the step of reviewing is accomplished by a speech recognition system.

11. The method of claim 10 wherein the step of reviewing comprises reviewing the voice communication for one or more of a telephone number, URL and e-mail address.

12. The method of claim 7, further comprising a step of recording the voice communication, yielding a recorded voice communication, the step of reviewing comprising reviewing at least a portion of the recorded voice communication.

13. The method of claim 12, wherein the step of reviewing comprises reviewing at least a portion of the voice communication occurring prior to the request for targeted voice recognition.

14. The method of claim 12, wherein the step of reviewing comprises reviewing at least a portion of the voice communication occurring after the request for targeted voice recognition.

15. The method of claim 12, wherein the step of reviewing comprises reviewing portions of the voice communication occurring before and after the request for targeted voice recognition.

16. The method of claim 7, wherein the step of providing one or more of a delivery option and connection option comprises:
sending a message to the party indicating availability of one or more delivery options;
receiving a request from the party to invoke a selected delivery option; and
responsive to the request, delivering a message including the targeted information to the party according to the selected delivery option.

17. The method of claim 16, wherein the step of delivering a message comprises delivering a text message including the target information.

18. The method of claim 7, wherein the step of providing one or more of a delivery option and connection option comprises:
sending a message to the party indicating availability of one or more connection options;
receiving a request from the party to invoke a selected connection option; and
responsive to the request, connecting the party to a communication device associated with the targeted information according to the selected connection option.
